(19) United States
(12) Patent Application Publication
(10) Pub. No.: US 2016/0080974 A1
(43) Pub. Date: Mar. 17, 2016

(54) SYSTEMS AND METHODS FOR ADJUSTING AN OPERATING CHARACTERISTIC OF A WIRELESS COMMUNICATION NETWORK BASED ON LOAD TO INCREASE QUALITY OF SERVICE

(71) Applicant: QUALCOMM Incorporated, San Diego, CA (US)

(72) Inventors: Gwendolyn Denise Barriac, Encinitas, CA (US); George Cherian, San Diego, CA (US); Simone Merlin, San Diego, CA (US); Yan Zhou, San Diego, CA (US)

(21) Appl. No.: 14/852,278

(22) Filed: Sep. 11, 2015

Related U.S. Application Data
(60) Provisional application No. 62/050,681, filed on Sep. 15, 2014.

(51) Int. Cl. H04W 28/08; H04W 74/06; H04W 24/10; H04W 28/12; H04W 72/08; H04W 28/02

(52) U.S. Cl. CPC H04W 28/08; H04W 72/087; H04W 28/0247; H04W 28/0268; H04W 24/10; H04W 28/12; H04W 74/06

(57) ABSTRACT

Methods and apparatus for adjusting an operating characteristic of a wireless communication network based on load to increase quality of service (QoS) are disclosed herein. One aspect of the present disclosure provides a method of communicating in a wireless communication network including a plurality of stations. The method includes determining a load of the wireless communication network and whether one or more of the plurality of stations are satisfying their QoS requirements. The method further includes determining an adjustment to the wireless communication network based at least in part on the load of the wireless communication network so as to increase a number of the plurality of stations that satisfy their QoS requirements, the adjustment based on one or more of a clear channel assessment threshold and/or a request to send and clear to send messaging in.

### CROSS REFERENCE TO PRIORITY APPLICATION

This application claims priority under 35 U.S.C. §119(e) to U.S. Provisional Patent Application 62/050,681 entitled “SYSTEMS AND METHODS FOR ADJUSTING CLEAR CHANNEL ASSESSMENT LEVELS TO INCREASE WIRELESS COMMUNICATION NETWORK THROUGHPUT” filed on Sep. 15, 2014, the disclosure of which is hereby incorporated by reference in its entirety.

### FIELD

Certain aspects of the present disclosure generally relate to wireless communications, and more particularly, to methods and apparatus for adjusting an operating characteristic of a wireless communication network based on load to increase quality of service.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

The devices in a wireless network can transmit/receive information between each other. Devices capable of transmitting/receiving greater amounts of data may consume more of the available bandwidth than necessary to achieve a minimum quality of service (QoS) requirement. This may negatively impact devices that are not capable of transmitting/receiving greater amounts of data, as such devices may have difficulty satisfying or meeting QoS requirements with less bandwidth available. As such, systems, methods, and non-transitory computer-readable media are needed for improving communication efficiency in wireless networks.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides a method of communicating in a wireless communication network including a plurality of stations. The method includes determining a load of the wireless communication network. The method further includes determining whether one or more of the plurality of stations are satisfying their quality of service (QoS) requirements. The method further includes determining an adjustment to the wireless communication network based at least in part on the load of the wireless communication network so as to increase a number of the plurality of stations that satisfy their QoS requirements, the adjustment based on one or more of a clear channel assessment threshold and/or a request to send and clear to send messaging in. In some aspects, the method further includes transmitting an indication of the adjustment to one or more of the plurality of stations.

Another aspect of the present disclosure provides an apparatus for communicating in a wireless communication network including a plurality of stations. The apparatus comprises a processor configured to determine a load of the wireless communication network. The processor is further configured to determine whether one or more of the plurality of stations are satisfying their quality of service (QoS) requirements. The processor is further configured to determine an adjustment to the wireless communication network based at least in part on the load of the wireless communication network so as to increase a number of the plurality of stations that satisfy their QoS requirements, the adjustment based on one or more of a clear channel assessment threshold and/or a request to send and clear to send messaging in. In some aspects, the apparatus further comprises a transmitter configured to transmit an indication of the adjustment to one or more of the plurality of stations.

Yet another aspect of the present disclosure provides an apparatus for communicating in a wireless communication network including a plurality of stations. The apparatus includes means for determining a load of the wireless communication network. The apparatus further includes means for determining whether one or more of the plurality of stations are satisfying their quality of service (QoS) requirements. The apparatus further includes means for determining an adjustment to the wireless communication network based at least in part on the load of the wireless communication network so as to increase a number of the plurality of stations that satisfy their QoS requirements, the adjustment based on one or more of a clear channel assessment threshold and/or a request to send and clear to send messaging in. In some aspects, the apparatus also includes means for transmitting an indication of the adjustment to one or more of the plurality of stations.

In yet another aspect, a non-transitory computer-readable medium comprising code is described that, when executed performs a method of communicating in a wireless communication network including a plurality of stations. The method comprises determining a load of the wireless communication network. The method further comprises determining whether one or more of the plurality of stations are satisfying their quality of service (QoS) requirements. The method further comprises determining an adjustment to the wireless communication network based at least in part on the load of the wireless communication network so as to increase a number of the plurality of stations that satisfy their QoS requirements. In some aspects, the method further comprises transmitting an indication of the adjustment to one or more of the plurality of stations.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1, in accordance with an embodiment.

FIG. 3 illustrates an exemplary method of communicating in a wireless communication network, in accordance with an embodiment.

FIG. 4 illustrates another exemplary method of communicating in a wireless communication network, in accordance with an embodiment.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein it will be appreciated that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to, or other than, the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes such as multiple-input and multiple-output (MIMO).

In some implementations, a WLAN includes various devices that access the wireless network. For example, there can be two types of devices: access points (“APs”) and clients (also referred to as stations, or “STAs”). In general, an AP serves as a hub or base station for the WLAN and an STA serves as a user of the WLAN. For example, a STA can be a laptop computer, a personal digital assistant (PDA), a mobile phone, etc. In some aspects, an STA connects to an AP via a Wi-Fi (e.g., IEEE 802.11 protocol such as 802.11ax) compliant wireless link to obtain general connectivity to the Internet or to other wide area networks (WAN). In some implementations an STA can also be used as an AP.

The techniques described herein can be used for various broadband wireless communication systems, including communication systems that are based on an orthogonal multiplexing scheme, such as Orthogonal Frequency Division Multiple Access (OFDMA). An OFDMA system utilizes orthogonal frequency division multiplexing (OFDM), which is a modulation technique that partitions the overall system bandwidth into multiple orthogonal sub-carriers. These sub-carriers can also be called tones, bins, etc.

The teachings herein can be incorporated into (e.g., implemented within or performed by) a variety of wired or wireless apparatuses (e.g., nodes). In some aspects, a wireless node implemented in accordance with the teachings herein can comprise an access point or an access terminal.

An access point (“AP”) can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

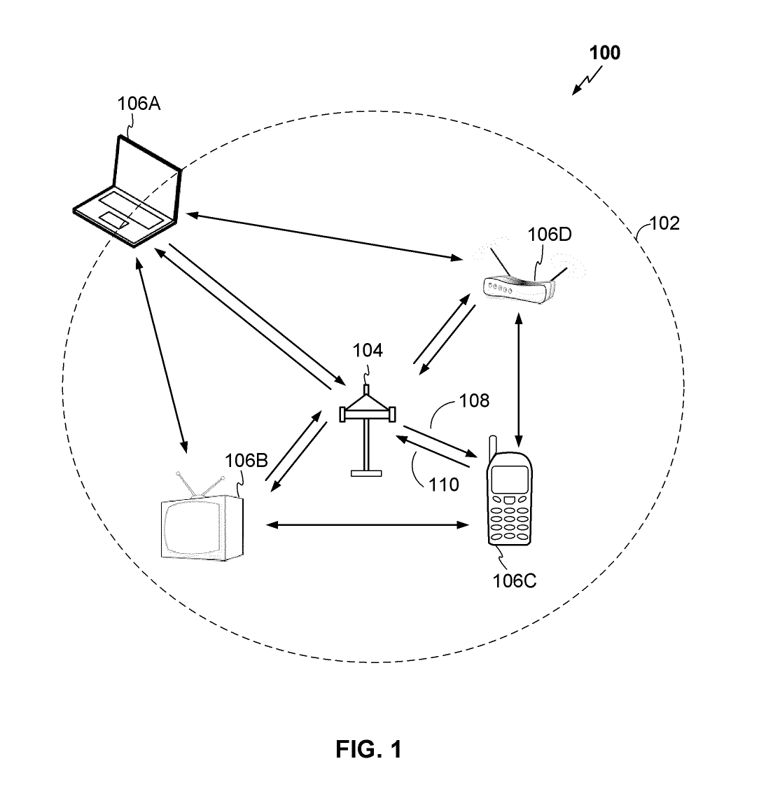

FIG. 1 illustrates an example of a wireless communication system or wireless communication network 100 in which aspects of the present disclosure can be employed. The wireless communication network 100 can operate pursuant to an IEEE 802.11 wireless standard such as, for example, the 802.11ax standard. The wireless communication network 100 can include an AP 104, which communicates with STAs 106A-D (referred to herein as “STA 106” or “STAs 106”).

A variety of processes and methods can be used for transmissions in the wireless communication network 100 between the AP 104 and the STAs 106. For example, in some aspects signals can be transmitted and received between the AP 104 and the STAs 106 in accordance with OFDMA techniques. In accordance with these aspects, the wireless communication network 100 can be referred to as an OFDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide wireless communication coverage in a basic service area (BSA) 102. The AP 104, along with the associated STAs 106 that utilize the AP 104 for communication, can be referred to as a basic service set (BSS). In some aspects, the phrase “BSS” may refer to as a wireless communication network. Although illustrated here as a circle, this coverage of the BSA 102 is merely illustrative. In some aspects, as illustrated, the STAs 106 may also communicate with each other, with or without the use of the AP 104. It should be noted that the wireless communication network 100 may not have a central AP 104, and may alternatively function as a peer-to-peer network between/among the STAs 106. Accordingly, the functions of the AP 104 described herein can additionally or alternatively be performed by one or more of the STAs 106.

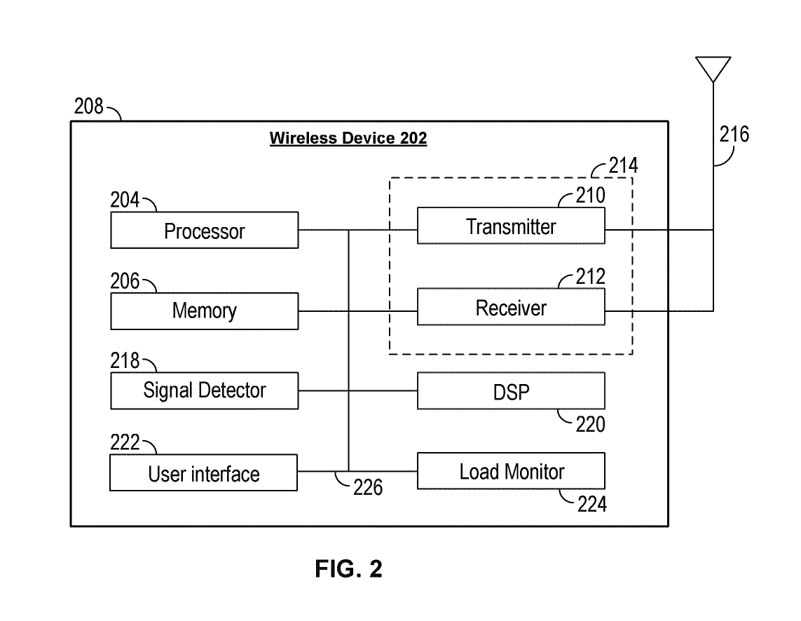

FIG. 2 illustrates various components that can be utilized in a wireless device 202 that can be employed within the wireless communication network 100 of FIG. 1, in accordance with an embodiment. The wireless device 202 is an example of a device that can be configured to implement the various methods described herein. In some aspects, the wireless device 202 can comprise the AP 104 or one of the STAs 106.

As illustrated, the wireless device 202 can include a processor 204, which may be configured to control the operation of the wireless device 202. The processor 204 can also be referred to as a central processing unit (CPU). As illustrated, the wireless device 202 can also include a memory 206, which can include one or both of read-only memory (ROM) and random access memory (RAM). In some aspects, the memory 206 stores or provides instructions or data that may be utilized by the processor 204. In one aspect, a portion of the memory 206 can also include non-volatile random access memory (NVRAM). The processor 204 can be configured to perform logical and arithmetic operations based on program instructions stored within the memory 206. In various embodiments, the instructions in the memory 206 can be executable (e.g., software) to implement the methods described herein.

In various aspects, the processor 204 can comprise, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). In various embodiments, the instructions, when executed by the one or more processors, cause the processing system to perform the various functions described herein.

The wireless device 202 can also include a housing 208, which can include a transmitter 210 and a receiver 212 to allow transmission and reception of data between the wireless device 202 and a remote location. In some aspects, the transmitter 210 and the receiver 212 can be combined into a transceiver 214. In various aspects, an antenna 216 can be attached to the housing 208 and electrically coupled to the transceiver 214. The wireless device 202 can also include (not shown) multiple transmitters, multiple receivers, multiple transceivers, and/or multiple antennas, which can be utilized during MIMO communications, for example.

As illustrated, the wireless device 202 can also include a signal detector 218 that can be used to detect and quantify the level of signals received by the transceiver 214. In some aspects, the signal detector 218 can detect the received signals as total energy, energy per subcarrier per symbol, power spectral density and other signals. As illustrated, the wireless device 202 can also include a digital signal processor (DSP) 220 for use in processing signals. In various aspects, the DSP 220 can be configured to generate a data unit for transmission. In some aspects, the generated data unit can comprise a physical layer data unit (PPDU), which may also be referred to as a “packet,” a “message” or a “frame.”

As illustrated, the wireless device 202 can further comprise a user interface 222. In some aspects, the user interface 222 can comprise a keypad, a microphone, a speaker, or a display. In accordance with various embodiments, the user interface 222 can include any element or component that conveys information to a user of the wireless device 202 or receives input from the user.

As illustrated, the wireless device 202 can further comprise a load monitor 224. In some aspects, the load monitor 224 can be used to determine or monitor a load of the network on which the wireless device 202 operates. For example, the AP 104 of FIG. 1 may comprise the wireless device 202, and the load monitor 224 may be configured to monitor the load of the wireless communication network 100 (e.g., the STAs 106 within the BSS). Based upon the load, the AP 104 may determine whether an operating characteristic of the wireless communication network 100 should be modified or changed. For example, when the determined load exceeds a specific threshold, a clear channel assessment (CCA) level of one or more of the STAs 106 may be changed, or request-to-send (RTX) and clear-to-send (CTX) messaging may be turned on or off. Using the load monitor 224 in this manner may increase the overall number of STAs 106 that achieve their target quality of service (QoS) rate, as described in further detail below. In some aspects, the load monitor 224 may utilize the processor 204, the memory 206, the signal detector 218, or the DSP 220 to carry out these functions. Upon determining to change an operating characteristic of the wireless communication network 100, the AP 104 may utilize the transmitter 210, the receiver 212, or the transceiver 214 to communicate the change to the STAs 106 within the BSS.

There may be several possible ways of calculating the “load” of the wireless communication network 100. For example, the load monitor 224 may determine traffic requirements of the wireless communication network 100. In some aspects, the traffic requirements may be based one or more of a number of STAs 106 to be served over a specified period of time, a number of uplink packets received by the AP 104, a buffer requirement of one or more of the STAs 106, and a number of retransmissions received by the AP 104. In some aspects, the buffer requirements of one or more of the STAs 106 can be received, by the AP 104, via one or more of a high-efficiency control field of a high-efficiency control frame transmitted by one or more of the STAs 106, a more data bit of a data frame transmitted by one or more of STAs 106, and random access polling of one or more of the STAs 106.

The load monitor 224 may compare one or more of these traffic requirements individually against a given threshold value corresponding to the individual traffic requirement. In some aspects, the load monitor 224 may determine that the load of the wireless communication network 100 is “high” when an individual traffic requirement exceeds a first threshold. In some aspects, the load monitor 224 may determine that the load of the wireless communication network 100 is “low” when all of the individual traffic requirements are below a second threshold. In some embodiments, the first and second thresholds are not the same value, while in other embodiments, the first and second thresholds are the same value. In some aspects, the load monitor 224 may determine a weighted average based on more than one of the traffic requirements, and compare the weighted average against one or more threshold values to determine whether the load of the wireless communication network 100 is high or low.

Similarly, the load monitor 224 may determine a busyness of the wireless communication network 100. In some aspects, the busyness of the wireless communication network 100 may be based on determining an average channel load across each of the STAs 106 in the wireless communication network 100, a median channel load across each of the STAs 106, or a worst channel load across each of the STAs 106. Similar to above, the load monitor 224 may compare the determined busyness against a given threshold value to determine whether the load of the wireless communication network 100 is high or low. Different thresholds may be used for making the determination that the load is high as compared to the determination that the load is low. Similarly, the load monitor 224 may determine the busyness of the medium by measuring how often it detects energy above a certain level when STAs 106 in the BSS are not transmitting.

As illustrated, the various components of the wireless device 202 can be coupled together by a system bus 226. The system bus 226 can include a data bus, for example, as well as a power bus, a control signal bus, or a status signal bus in addition to the data bus. In various aspects, the components of the wireless device 202 can be coupled together, or accept or provide inputs to each, other using some other mechanism.

Although a number of separate components are illustrated in FIG. 2, one or more of the components can be combined or commonly implemented. For example, the processor 204 can be used to implement not only the functionality described above with respect to the processor 204, but also to implement the functionality described above with respect to the signal detector 218, the DSP 220, or the load monitor 224. Further, each of the components illustrated in FIG. 2 can be implemented using a plurality of separate elements.

As discussed above, the wireless device 202 can comprise an AP 104 or an STA 106, and can be used to transmit and/or receive data. In some aspects, the data units exchanged between the AP 104 and the STAs 106 can include data frames, control frames, and/or management frames. Data frames can be used for transmitting data from an AP 104 or a STA 106 to other APs 104 or STAs 106. Control frames can be used together with data frames for performing various operations or for reliably delivering data (e.g., acknowledging receipt of data, polling of APs 104 or STAs 106, area-clearing operations, channel acquisition, carrier-sensing maintenance functions, etc.). In some aspects, management frames can be used for various supervisory functions (e.g., for joining and departing from wireless networks, for indicating a change in communication parameters, for signaling a change in acknowledgment procedures, etc.).

As described above, in some aspects, a load monitor 224 of a wireless device 202 may be used to modify one or more operating characteristics of the wireless communication network 100 based on a determined load. In various aspects, an operating characteristic can comprise deferral rules. Deferral rules may be used by STAs 106 within the wireless communication network 100 to determine when to defer to other traffic on a wireless medium utilized by the wireless communication network 100, when to transmit on the wireless medium, how long to wait before attempting to access the wireless medium, etc.

In some aspects, the wireless communication network 100 may improve performance if an increased number of STAs 106 are able to achieve their QoS requirement(s). QoS requirements may refer to a minimum level of service that a STA 106 requests from, needs from, or otherwise negotiates with the wireless communication network 100 (e.g., with the AP 104). A QoS requirement for a STA 106 may be based on one or more factors, such as an error rate, a bit rate, a throughput, a transmission delay, availability, jitter, etc. For example, in an embodiment, a STA 106 may require a certain minimum throughput in order to satisfy or meet its target rate or some other QoS requirement. If a STA 106 is unable to satisfy its QoS requirement a user of the STA 106 (e.g., the device that comprises the STA 106) may experience issues with the service it is receiving or attempting to receive (e.g., a lower quality service). For example, a STA 106 that requires a minimum level of throughput to conduct an IP multimedia subsystem (IMS) voice call may drop the call if the QoS requirement for the service is not met, or may otherwise only be able to provide a low quality call to a user of the STA 106.

Increasing the number of STAs 106 that achieve their target QoS requirements may be preferred over other methods of increasing performance of a wireless communication network 100. For example, while increasing an overall throughput of the wireless communication network 100 may be desired, methods of doing so may be more likely to provide acceptable service to only some STAs 106 at the expense of other STAs 106. For instance, when the overall throughput of the wireless communication network 100 is increased, STAs 106 with normal connection access may be able to increase their individual throughput, while STAs 106 with poor connection access may not be able to increase their individual throughput, and in some aspects, may see a decrease in individual throughput. However, changing deferral rules of the wireless communication network 100 to benefit the STAs 106 with poor connection access may not have a substantial impact to the STAs 106 with normal connection access (e.g., without decreasing the number of STAs with normal access that achieve their target QoS). STAs with poor connection access may include STAs 106 that are further away from the AP 104, such as STA 106A of FIG. 1 (also referred to as an “edge” user), as it may be more difficult for these STAs 106 to access the wireless medium used by the wireless communication network 100. STAs 106 with “normal” connection access may refer to STAs 106 that are closer to the AP 104, such as STAs 106B, 106C, and 106D, as these STAs 106 may not encounter as many issues accessing the wireless medium that are based at least in part upon the distance away from the AP 104.

In some aspects, a STA 106 may compare an actual QoS it receives/perceives against its QoS requirements. In accordance with these aspects, the STA 106 that is not able to satisfy its target QoS requirements may transmit or otherwise provide an indication of this to a device providing the service (e.g., the AP 104). The device providing the service may determine, based at least in part upon receiving this indication, that deferral rules may need to be modified to increase the number of STAs 106 that are able to satisfy their target QoS requirements. In some aspects, the AP 104 may transmit a message to each STA 106 within the wireless communication network 100, informing the STAs of the deferral rules for the network. In some aspects, the AP 104 may additionally or alternatively broadcast a message in a beacon frame or using a management frame. In some aspects, the STAs 106 may change their deferral rules based on their QoS.

Deferral rules may take multiple forms. For example, in some aspects, clear channel assessment thresholds may be increased. In accordance with these aspects, before a device, such as a STA 106 or an AP 104, transmits on the wireless medium, that device may perform a clear channel assessment (CCA). This CCA may include, for example, determining an average amount of energy that is present on a particular portion of the channel during a particular time or time frame. These devices may compare the detected amount of energy to a clear channel assessment threshold, in order to determine whether or not the wireless medium is in use. For example, if there is a large amount of energy in the spectrum at a particular time, the devices may determine that this portion of the spectrum is in use, and may choose not to transmit on this portion of the spectrum at that time. Accordingly, this CCA threshold may be altered in order to increase the number of devices that are able to access the wireless medium. Adjusting this CCA threshold, depending upon the direction of the adjustment, may be referred to herein as “loosening” or “tightening” the deferral rules for the wireless communication network 100, as it may make devices either more or less likely to defer to the traffic present on the wireless medium. In some aspects, loosening or tightening deferral rules may be done for an entire wireless communication network 100, or may be done on a per STA 106 basis.

For example, in some aspects, decreasing the CCA threshold when a load of the wireless communication network 100 is low may provide increased QoS for STAs 106 with poor connection access. In accordance with these aspects, the number of STAs 106 with poor connection access that are able to satisfy their target QoS requirement may increase, while the number of STAs 106 with normal connection access that are able to satisfy their target QoS requirement may stay roughly the same.

By way of a non-limiting example, a wireless communication network 100 may have fifty STAs 106 with normal connection access and thirty STAs 106 with poor connection access. If the AP 104 determines that the load of the wireless communication network 100 comprising these STAs 106 is below a certain threshold, the AP 104 may indicate to the STAs 106 that they are to decrease their CCA thresholds. By doing so, twenty five of the STAs 106 with poor connection access may be able to satisfy their target QoS requirements (e.g., obtain sufficient use of the wireless medium), and fifty of the STAs 106 with normal connection access may be able to continue to satisfy their target QoS requirements. If, however, the AP 104 does not indicate to the STAs 106 of the wireless communication network 100 that they are to decrease their CCA thresholds, then only five of the STAs 106 with poor connection access may be able to satisfy their target QoS requirements while the same fifty of the STAs 106 with normal connection access are able to satisfy their target QoS requirements. This may occur because the STAs 106 with normal connection access may utilize more of the available bandwidth than necessary to satisfy their target QoS requirements, leaving less available bandwidth for the STAs 106 with poor connection capabilities. Accordingly, a non-limiting example of a benefit of decreasing CCA thresholds in a lightly loaded network may be that an overall number of wireless devices that are able to satisfy their target QoS requirements is increased.

Similarly, deferral rules may be adjusted based on turning on request-to-send (RTX) and clear-to-send (CTX) messaging. For example, if the AP 104 determines that the load of the wireless communication network 100 is below a certain threshold, the AP 104 may additionally or alternatively indicate to the STAs 106 that they are to utilize RTX and CTX messaging. By doing so, the STAs 106 with poor connection access may have an easier time accessing the wireless medium because RTX and CTX messaging may afford the STAs 106 in the wireless communication network 100 with an opportunity to schedule specific times to access the wireless medium. Providing the opportunity to schedule access may increase the likelihood that a given STA 106 meets its target QoS requirement(s), as less contention may be necessary, and therefore less deferral by the given STA 106 to other STAs 106 may occur. Accordingly, a non-limiting example of a benefit of turning RTX and CTX messaging on in a lightly loaded network may be that an overall number of wireless devices that are able to satisfy their target QoS requirements is increased.

In some aspects, additionally or alternatively increasing the CCA threshold when a load of the wireless communication network 100 exceeds a specified threshold may provide increased access to STAs 106 with normal connection access. In accordance with these aspects, the number of STAs 106 with normal connection access that are able to satisfy their target QoS requirement may increase, while the number of STAs 106 with normal connection access that are able to satisfy their target QoS requirement may decrease.

By way of a non-limiting example, a wireless communication network 100 may have fifty STAs 106 with normal connection access and thirty STAs 106 with poor connection access. If the AP 104 determines that the load of the wireless communication network 100 comprising these STAs 106 is above a certain threshold, the AP 104 may indicate to the STAs 106 that they are to increase their CCA thresholds. By doing so, five of the STAs 106 with poor connection access may be able to satisfy their target QoS requirements, and fifty of the STAs 106 with normal connection access may be able to satisfy their target QoS requirements. If, however, the AP 104 does not indicate to the STAs 106 of the wireless communication network 100 that they are to increase their CCA thresholds, then ten of the STAs 106 with poor connection access may be able to satisfy their target QoS requirements while only thirty of the STAs 106 with normal connection access are able to satisfy their target QoS requirements. This may occur because the STAs 106 with poor connection access may utilize more of the available bandwidth to satisfy or attempt to satisfy their target QoS requirements, leaving less available bandwidth for the STAs 106 with normal connection capabilities. Accordingly, a non-limiting example of a benefit of increasing CCA thresholds in a heavily loaded network may be that an overall number of wireless devices that are able to satisfy their target QoS requirements is increased.

Similarly, deferral rules may be adjusted based on turning off request-to-send (RTX) and clear-to-send (CTX) messaging. For example, if the AP 104 determines that the load of the wireless communication network 100 is above a certain threshold, the AP 104 may additionally or alternatively indicate to the STAs 106 that they are not to use RTX and CTX messaging. By doing so, the STAs 106 with normal connection access may have an easier time accessing the wireless medium because RTX and CTX messaging may consume additional bandwidth, can over-silence the medium, and decrease the likelihood that a given STA 106 will be able to utilize the wireless medium to satisfy its target QoS requirement(s). Accordingly, a non-limiting example of a benefit of turning RTX and CTX messaging off in a heavily loaded network may be that an overall number of wireless devices that are able to satisfy their target QoS requirements is increased.

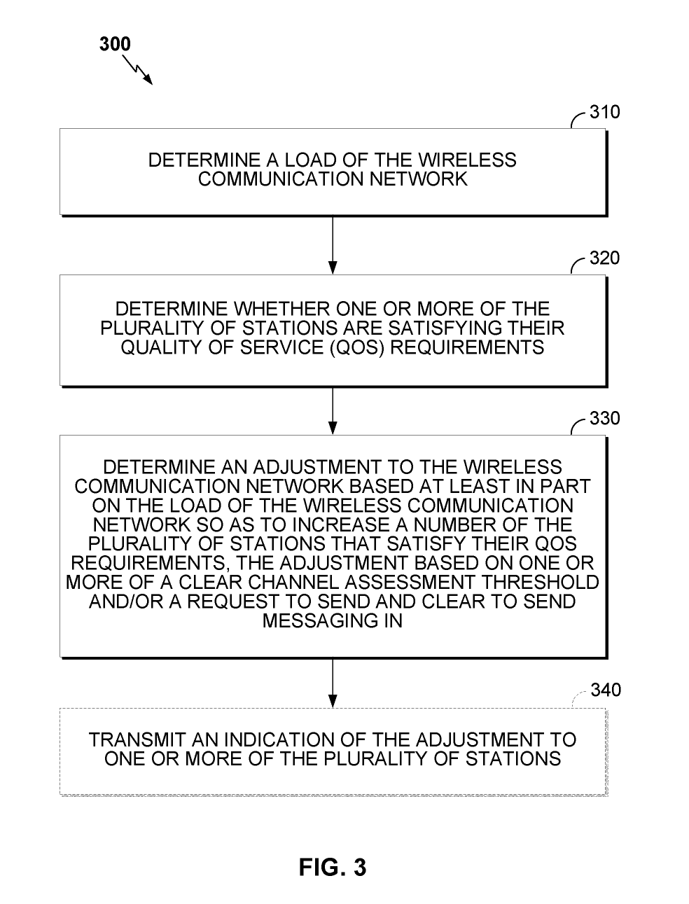

FIG. 3 illustrates an exemplary method 300 of communicating in a wireless communication network 100, in accordance with an embodiment. The wireless communication network 100 may include a plurality of STAs 106. This method 300 may be performed by, for example, an AP such as AP 104 of FIG. 1. In some aspects, the AP 104 may be configured to transmit indications of deferral rules to the devices within the wireless communication network 100 (e.g., STAs 106A-D of FIG. 1), and those device may be configured to use the deferral rules which they receive from the AP 104. In some aspects, a STA such as one of the STAs 106 of FIG. 1 may perform method 300.

Method 300 may start at block 310, wherein the AP 104, for example, may determine a load of the wireless communication network 100. In some aspects, determining the load comprises determining traffic requirements of the wireless communication network 100. In accordance with these aspects, the traffic requirements are based upon one or more of a number of the plurality of STAs 106 in the wireless communication network 100 to be served over a period of time, a number of uplink packets received by the AP 104, a buffer requirement of one or more of the plurality of STAs 106, and a number of retransmissions received by the AP 104, or an amount of time the energy on the medium exceeds a certain threshold when STAs 106 in the BSS devices are not transmitting. In various aspects, the buffer requirement of one or more of the plurality of STAs 106 can be received, by the AP 104, via one or more of a high-efficiency control field of a high-efficiency control frame transmitted by one or more of the plurality of STAs 106, random access polling of one or more of the plurality of STAs 106, and a more data bit of a data frame transmitted by one or more of the plurality of STAs 106. In some aspects, one or more of the means for determining may comprise a processor, a load monitor, or a memory, such as one or more of the processor 204, the memory 206, the DSP 220, the load monitor 224, or their functional equivalents.

In some aspects, determining the load comprises determining a busyness of a wireless communication medium utilized by the wireless communication network 100. In accordance with these aspects, determining the busyness may comprise one or more of determining an average channel load across each of the plurality of STAs 106, determining a median channel load across each of the plurality of STAs 106, and determining a worst channel load across each of the plurality of STAs 106.

Method 300 may proceed to block 320, wherein the AP 104, for example, may determine whether one or more of the plurality of STAs 106 are satisfying their quality of service (QoS) requirements. In some aspects, method 300 may not involve determining whether one or more of the plurality of STAs 106 are satisfying their QoS requirements, and may instead perform method 300 periodically, or based on the occurrence of some other event or trigger.

Method 300 may proceed to block 330, wherein the AP 104, for example, may determine an adjustment to the wireless communication network 100 based at least in part on the load of the wireless communication network so as to increase a number of the plurality of stations that satisfy their QoS requirements, the adjustment based on one or more of a clear channel assessment (CCA) threshold and/or a request to send and clear to send messaging in. In some aspects, the determined adjustment comprises decreasing the CCA threshold when the determined load is below a load threshold value. In some aspects, the determined adjustment comprises increasing the CCA threshold when the determined load is above a load threshold value. In some aspects, the determined adjustment comprises turning the request to send and clear to send messaging on when the determined load is below a load threshold value. In some aspects, the determined adjustment comprises turning the request to send and clear to send messaging off when the determined load is above a load threshold value. In various aspects, the determined adjustment may apply on a per STA 106 basis, or may apply to all of the plurality of STAs 106 in the wireless communication network 100. In some aspects, means for decreasing a clear channel assessment threshold may comprise a processor, a load monitor, or a memory, such as one or more of the processor 204, the memory 206, the DSP 220, the load monitor 224, or their functional equivalents. In some aspects, means for increasing a clear channel assessment threshold may comprise a processor, a load monitor, or a memory, such as one or more of the processor 204, the memory 206, the DSP 220, the load monitor 224, or their functional equivalents. In some aspects, means for turning a request to send and clear to send messaging on or off may comprise a processor, a load monitor, or a memory, such as one or more of the processor 204, the memory 206, the DSP 220, the load monitor 224, or their functional equivalents.

Method 300 may optionally proceed to block 340 (illustrated in dashed lines), wherein the AP 104, for example, may transmit an indication of the adjustment to one or more of the plurality of STAs 106. In some aspects, transmitting the indication comprises transmitting the indication in a beacon or in a broadcast management frame. In some aspects, means for transmitting may comprise a transmitter or a receiver, such as one or more of the transmitter 210, the transceiver 214, or their functional equivalents. As noted above, in some aspects, a STA 106 may perform method 300. In accordance with these aspects, the STA 106 may adjust a CCA threshold, or turn RTX and CTX messaging on or off, based on the determined adjustment.

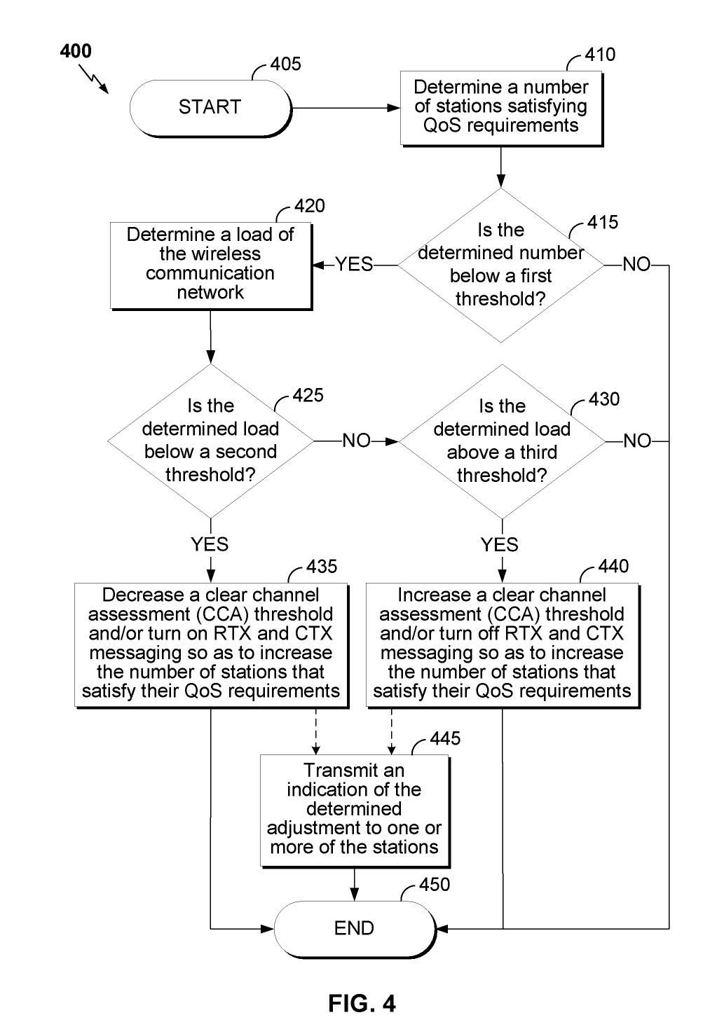

FIG. 4 illustrates another exemplary method 400 of communicating in a wireless communication network 100, in accordance with an embodiment. This method 400 may be performed by, for example, an AP such as AP 104 of FIG. 1. In some aspects, the AP 104 may be configured to transmit indications of deferral rules to the devices within the wireless communication network 100 (e.g., STAs 106A-D of FIG. 1), and those device may be configured to use the deferral rules which they receive from the AP 104. In some aspects, a STA 106 may perform method similar to method 400.

Method 400 may start at block 405, where the AP 104, for example, may be providing a service to plurality of STAs 106.

Method 400 may then proceed to block 410, where the AP 104 may determine a number of the plurality of STAs 106 that satisfy their QoS requirements. In some aspects, this determination may be made based at least in part upon information transmitted by each of the plurality of STAs 106. For example, a STA 106 that does not satisfy its target QoS requirement(s) may transmit an indication to the AP 104 that the STA 106 is not satisfying its target QoS requirement. Based upon this information, the AP 104 may be aware of how many of the plurality of STAs 106 it serves that are satisfying their target QoS requirements.

Method 400 may then proceed to decision block 415, where the AP 104 may determine whether the determined number of the plurality of STAs 106 that are satisfying their target QoS requirements is below a first threshold. If the AP 104 determines that the determined number is not below the first threshold, the method 400 may then proceed to block 450 where the method 400 ends. However, if the AP 104 determines that the determined number is below the first threshold, the method 400 may then proceed to block 420, where the AP 104 may determine a load of the wireless communication network 100. As described above, the load may be determined based upon traffic requirements, busyness, or both. In some aspects, the determined number of the plurality of STAs 106 may instead comprise a percentage or ratio of the number of devices that are satisfying (or not satisfying) their target QoS requirements compared to the number of devices being served by the AP 104.

Method 400 may then proceed to decision block 425, where the AP 104 may determine whether the determined load is below a second threshold. In various aspects, the second threshold is different from the first threshold used in decision block 415. If the AP 104 determines that the determined load is not below the second threshold, then method 400 may then proceed to decision block 430, where the AP 104 may determine whether the determined load is above a third threshold. In various aspects, the third threshold is different from the first threshold used in decision block 415 and the second threshold used in decision block 425. In other aspects, the third threshold may be the same as the second threshold. If the AP 104 determines that the load is not above the third threshold, then method 400 may then proceed to block 450, where the method ends.

If, however, the AP 104 determines at decision block 425 that the determined load is below the second threshold, then method 400 may then proceed to block 435, where the AP 104 may determine to decrease a CCA threshold and/or turn on RTX and CTX messaging so as to increase the number of STAs 106 satisfying their QoS requirements. Thereafter, method 400 may proceed to block 450, where the method 400 ends. However, in some aspects, method 400 may optionally proceed from block 435 to block 445, where the AP 104 may transmit an indication of the determined adjustment to one or more of the plurality of STAs 106. Thereafter, method 400 may proceed to block 450, where the method 400 ends.

If, however, the AP 104 determines at decision block 430 that the determined load is above the third threshold, then method 400 may then proceed to block 440, where the AP 104 may determine to increase a CCA threshold and/or turn off RTX and CTX messaging so as to increase the number of stations that satisfy their QoS requirements. Thereafter, method 400 may proceed to block 450, where the method 400 ends. However, in some aspects, method 400 may optionally proceed from block 440 to block 445, where the AP 104 may transmit an indication of the determined adjustment to one or more of the plurality of STAs 106. Thereafter, method 400 may proceed to block 450, where the method 400 ends.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, the terms “and” or “or” may be interchangeable, and may be interpreted as “and/or” (e.g., anywhere from one to all of the items in a list).

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. A method of communicating in a wireless communication network that includes a plurality of stations, the method comprising:
determining a load of the wireless communication network;
determining whether one or more of the plurality of stations are satisfying their quality of service (QoS) requirements; and
determining an adjustment to the wireless communication network based at least in part on the load of the wireless communication network so as to increase a number of the plurality of stations that satisfy their QoS requirements, the adjustment based on one or more of a clear channel assessment threshold and/or a request to send and clear to send messaging in.

2. The method of claim 1, wherein the adjustment comprises decreasing the clear channel assessment threshold when the load of the wireless communication network is below a load threshold value.

3. The method of claim 1, wherein the adjustment comprises increasing the clear channel assessment threshold when the load of the wireless communication network is above a load threshold value.

4. The method of claim 1, wherein the adjustment comprises turning the request to send and clear to send messaging on when the load of the wireless communication network is below a load threshold value.

5. The method of claim 1, wherein the adjustment comprises turning the request to send and clear to send messaging off when the load of the wireless communication network is above a load threshold value.

6. The method of claim 1, wherein determining the load comprises determining traffic requirements of the wireless communication network, and wherein the traffic requirements are based upon one or more of:
a number of the plurality of stations to be served over a period of time;
a number of uplink packets received by an access point in the wireless communication network;
a buffer requirement of one or more of the plurality of stations; and
a number of retransmissions received by the access point in the wireless communication network.

7. The method of claim 6, wherein the buffer requirement is received via one or more of:
a high-efficiency control field of a high-efficiency control frame transmitted by one or more of the plurality of stations;
random access polling of one or more of the plurality of stations; and
a more data bit of a data frame transmitted by one or more of the plurality of stations.

8. The method of claim 1, wherein determining the load comprises determining a busyness of a wireless communication medium utilized by the wireless communication network, and wherein determining the busyness comprises one or more of:
determining an average channel load across each of the plurality of stations;
determining a median channel load across each of the plurality of stations; and
determining a worst channel load across each of the plurality of stations.

9. The method of claim 1, further comprising transmitting an indication of the adjustment to one or more of the plurality of stations.

10. An apparatus for communicating in a wireless communication network including a plurality of stations, the apparatus comprising:
a processor configured to:
determine a load of the wireless communication network;
determine whether one or more of the plurality of stations are satisfying their quality of service (QoS) requirements; and
determine an adjustment to the wireless communication network based at least in part on the load of the wireless communication network so as to increase a number of the plurality of stations that satisfy their QoS requirements, the adjustment based on one or more of a clear channel assessment threshold and/or a request to send and clear to send messaging in.

11. The apparatus of claim 10, wherein the processor is further configured to decrease the clear channel assessment threshold when the load of the wireless communication network is below a load threshold value.

12. The apparatus of claim 10, wherein the processor is further configured to increase the clear channel assessment threshold when the load of the wireless communication network is above a load threshold value.

13. The apparatus of claim 10, wherein the processor is further configured to turn the request to send and clear to send messaging on when the load of the wireless communication network is below a load threshold value.

14. The apparatus of claim 10, wherein the processor is further configured to turn the request to send and clear to send messaging off when the load of the wireless communication network is above a load threshold value.

15. The apparatus of claim 10, wherein the processor is further configured to determine the load based on traffic requirements of the wireless communication network, and wherein the traffic requirements are based upon one or more of:
a number of the plurality of stations to be served over a period of time;
a number of uplink packets received by an access point in the wireless communication network;
a buffer requirement of one or more of the plurality of stations; and
a number of retransmissions received by the access point in the wireless communication network.

16. The apparatus of claim 15, further comprising a receiver configured to receive the buffer requirement via one or more of:
a high-efficiency control field of a high-efficiency control frame transmitted by one or more of the plurality of stations;
random access polling of one or more of the plurality of stations; and
a more data bit of a data frame transmitted by one or more of the plurality of stations.

17. The apparatus of claim 10, wherein the processor is further configured to determine the load based on determining a busyness of a wireless communication medium utilized by the wireless communication network, and wherein the busyness is determined based on one or more of:
an average channel load across each of the plurality of stations;
a median channel load across each of the plurality of stations; and
a worst channel load across each of the plurality of stations.

18. The apparatus of claim 10, further comprising a transmitter configured to transmit an indication of the adjustment to one or more of the plurality of stations.

19. An apparatus for communicating in a wireless communication network including a plurality of stations, the apparatus comprising:
means for determining a load of the wireless communication network;
means for determining whether one or more of the plurality of stations are satisfying their quality of service (QoS) requirements; and
means for determining an adjustment to the wireless communication network based at least in part on the load so as to increase a number of the plurality of stations that satisfy their QoS requirements, the adjustment based on one or more of a clear channel assessment threshold and/or a request to send and clear to send messaging in.

20. The apparatus of claim 19, further comprising means for decreasing the clear channel assessment threshold when the load of the wireless communication network is below a load threshold value.

21. The apparatus of claim 19, further comprising means for increasing the clear channel assessment threshold when the load of the wireless communication network is above a load threshold value.

22. The apparatus of claim 19, further comprising means for turning the request to send and clear to send messaging on when the load of the wireless communication network is below a load threshold value.

23. The apparatus of claim 19, further comprising means for determining the load based on traffic requirements of the wireless communication network, wherein the traffic requirements are based upon one or more of:
a number of the plurality of stations to be served over a period of time;
a number of uplink packets received by an access point in the wireless communication network;
a buffer requirement of one or more of the plurality of stations; and
a number of retransmissions received by the access point in the wireless communication network.

24. The apparatus of claim 19, further comprising means for determining the load based on determining a busyness of a wireless communication medium utilized by the wireless communication network, wherein the busyness is determined based on one or more of:
an average channel load across each of the plurality of stations;
a median channel load across each of the plurality of stations; and
a worst channel load across each of the plurality of stations.

25. A non-transitory computer-readable medium comprising code that, when executed, performs a method of communicating in a wireless communication network including a plurality of stations, the method comprising:
determining a load of the wireless communication network;
determining whether one or more of the plurality of stations are satisfying their quality of service (QoS) requirements; and
determining an adjustment to the wireless communication network based at least in part on the load of the wireless communication network so as to increase a number of the plurality of stations that satisfy their QoS requirements, the adjustment based on one or more of a clear channel assessment threshold and/or a request to send and clear to send messaging in.

26. The non-transitory computer-readable medium of claim 25, wherein the adjustment comprises decreasing the clear channel assessment threshold when the load of the wireless communication network is below a load threshold value.

27. The non-transitory computer-readable medium of claim 25, wherein the adjustment comprises increasing the clear channel assessment threshold when the load of the wireless communication network is above a load threshold value.

28. The non-transitory computer-readable medium of claim 25, wherein the adjustment comprises turning the request to send and clear to send messaging on when the load of the wireless communication network is below a load threshold value.

29. The non-transitory computer-readable medium of claim 25, wherein determining the load comprises determining traffic requirements of the wireless communication network, and wherein the traffic requirements are based upon one or more of:
a number of the plurality of stations to be served over a period of time;
a number of uplink packets received by an access point in the wireless communication network;
a buffer requirement of one or more of the plurality of stations; and
a number of retransmissions received by the access point in the wireless communication network.

30. The non-transitory computer-readable medium of claim 25, wherein determining the load comprises determining a busyness of a wireless communication medium utilized by the wireless communication network, and wherein determining the busyness comprises one or more of:
determining an average channel load across each of the plurality of stations;
determining a median channel load across each of the plurality of stations; and
determining a worst channel load across each of the plurality of stations.
